(19) United States
(12) Patent Application Publication
(10) Pub. No.: US 2004/0120717 A1
(43) Pub. Date: Jun. 24, 2004

(54) Extended source free-space optical communication system

(75) Inventors: Gerald R. Clark, San Diego, CA (US); Everett Jacob Marttila JR., Poway, CA (US)

Correspondence Address: FITCH EVEN TABIN AND FLANNERY, 120 SOUTH LA SALLE STREET, SUITE 1600, CHICAGO, IL, 60603-3406, US

(73) Assignee: LightPointe Communications, Inc., San Diego, CA

(21) Appl. No.: 10/322,866

(22) Filed: Dec. 18, 2002

(51) Int. Cl. H04B 10/00

(52) U.S. Cl. 398/118; 398/128

(57) ABSTRACT

The present invention provides an apparatus and method for free space optical communication. The apparatus includes a first optical source configured to generate a first optical beam, a first optical beam carrier optically aligned with the first optical source and configured to propagate at least a portion of the first optical beam, and an extended source optically aligned with the first optical beam carrier and configured to output an extended source optical beam. The extended source can include an extended source telescope configured to direct at least a portion of the first optical beam to output the extended source optical beam into free-space. Alternative the extended source can include a large core fiber optic cable configured to propagate at least a portion of the first optical beam exercising additional modes of the large core fiber cable to generate the extended source optical beam.

### BACKGROUND OF THE INVENTION

1. Field of the Invention

The present invention relates generally to free-space optical communication, and more specifically to the utilization of extended source lasers in the generation of free-space optical beams.

2. Discussion of the Related Art

For digital data communications, optical media offers many advantages compared to wired and RF media. Large amounts of information can be encoded into optical signals, and the optical signals are not subject to many of the interference and noise problems that adversely influence wired electrical communications and RF broadcasts. Furthermore, optical techniques are theoretically capable of encoding up to three orders of magnitude more information than can be practically encoded onto wired electrical or broadcast RF communications, thus offering the advantage of carrying much more information.

Fiber optics are the most prevalent type of conductors used to carry optical signals. An enormous amount of information can be transmitted over fiber optic conductors. A major disadvantage of fiber optic conductors, however, is that they must be physically installed. Free-space atmospheric links have also been employed to communicate information optically. A free-space link extends in a line of sight path between the optical transmitter and the optical receiver. Free-space optical links have the advantage of not requiring a physical installation of conductors. Free-space optical links also offer the advantage of higher selectivity in eliminating sources of interference, because the optical links can be focused directly between the optical transmitters and receivers, better than RF communications, which are broadcast with far less directionality. Therefore, any adverse influences not present in this direct, line-of-sight path or link will not interfere with optical signals communicated.

Despite their advantages, optical free-space links present problems. The quality and power of the optical signal transmitted depends significantly on the atmospheric conditions existing between the optical transmitter and optical receiver at the ends of the link. Rain drops, fog, snow, smoke, dust or the like in the atmosphere will absorb, refract or scatter the optical beam, causing a reduction or attenuation in the optical power at the receiver. Indeed, one of the key issues that plagues free-space optics is fog. The length of the free-space optical link also influences the amount of power attenuation via Beers' Law, longer free-space links will naturally contain more atmospheric factors to potentially attenuate the optical beam than shorter links. Furthermore, optical beams naturally diverge as they travel greater distances. The resulting beam divergence reduces the amount of power available for detection.

It is with respect to these and other background information factors relevant to the field of optical communications that the present invention has evolved.

### SUMMARY OF THE INVENTION

The present invention advantageously addresses the needs above as well as other needs by providing an apparatus and method of communicating optical signals over a free-space link. The apparatus includes a first optical source configured to generate a first optical beam; a first optical beam carrier optically aligned with the first optical source and configured to propagate at least a portion of the first optical beam; and an extended source optically aligned with the first optical beam carrier and configured to output an extended source optical beam.

In one embodiment, the extended source includes an extended source telescope optically aligned with the first optical beam carrier and configured to direct at least a portion of the first optical beam to output the extended source optical beam into free-space. In an alternative embodiment the extended source includes a large core fiber optic cable optically aligned with the first optical beam carrier and configured to propagate at least a portion of the first optical beam, wherein the large core fiber cable outputs the extended source optical beam and exercises additional modes of the large core fiber cable to generate the extended source optical beam.

In one embodiment, the invention provides an apparatus for optically communicating over free space. The apparatus includes a plurality of optical beam sources; and an extended source optical beam generator optically aligned with the plurality of optical beam sources to receive a plurality of optical beams and to transmit an extended source output beam.

The present invention additionally provides a method of optically communicating over free-space. The method comprises the steps of generating a first optical signal; coupling the first optical signal to an extended optical signal source; and generating an extended source output.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 depicts a simplified block diagram of a free-space optical communication network 102 according to one embodiment of the present invention;

FIG. 2 depicts a simplified anatomical diagram of a cross-sectional view of the human eye;

FIG. 3 depicts a simplified block diagram of one method for measuring power density levels;

FIG. 4 depicts a simplified block diagram of an extended laser transmission source;

FIG. 5 depicts simplified block diagram cross-sectional view of a large core fiber with a fiber clamp position on or about the fiber;

FIG. 6 depicts a simplified block diagram of an elevated view of an optical fiber that includes a jog or generally “S” shaped bend;

FIG. 7 depicts a simplified schematic diagram of multi-laser source according to one embodiment of the present invention;

FIG. 8 depicts a simplified block diagram cross-sectional view of a wave guide;

FIG. 9 depicts a simplified block diagram cross-sectional view of a telescope 310 configured as an extended light source;

FIG. 10 depicts a simplified block diagram of a VCSEL array mounted onto a card or circuit board;

FIG. 11 depicts a simplified block diagram of a scalable optical laser source; and

FIG. 12 depicts a simplified block diagram cross-sectional view of a free-space optical transmitter.

Corresponding reference characters indicate corresponding components throughout the several views of the drawings.

### DETAILED DESCRIPTION

The following description is not to be taken in a limiting sense, but is made merely for the purpose of describing the general principles of the invention. The scope of the invention should be determined with reference to the claims.

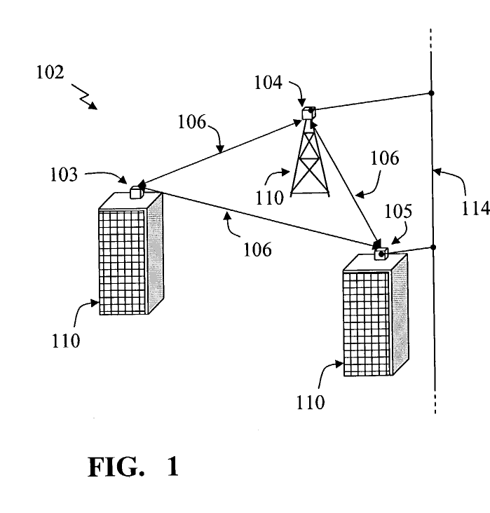

The present invention provides an apparatus and method for optically communicating over free-space. FIG. 1 depicts a simplified block diagram of a free-space optical communication network 102 according to one embodiment of the present invention. The network includes a plurality of link heads 103, 104 and 105. Each link head comprises a transmitter, a receiver or both a transmitter and receiver (i.e., a transceiver). A link head 103-105 is optically aligned with at least one other link head on opposite sides of one or more free-space links 106. The link heads are mounted to structures 110, such as buildings, antennas, bridges, houses and other structures. The link heads can be coupled with a network 114, such as the Internet, an inter-campus network, a Public Switched Telephone Network (PSTN), cable television, cellular backhaul or other networks capable of communicating data and/or information.

Previous free-space optical communication sources operate, typically at wavelengths near Infrared, e.g., between about 800 nm and 1600 nm. Many countries limit the amount of power at which optical signals at these wavelengths can be transmitted over free-space. For example, the International Engineering Consortium (IEC) has generated limits that are followed in many countries for the amount of optical power density at which a free-space optical beam can be generated.

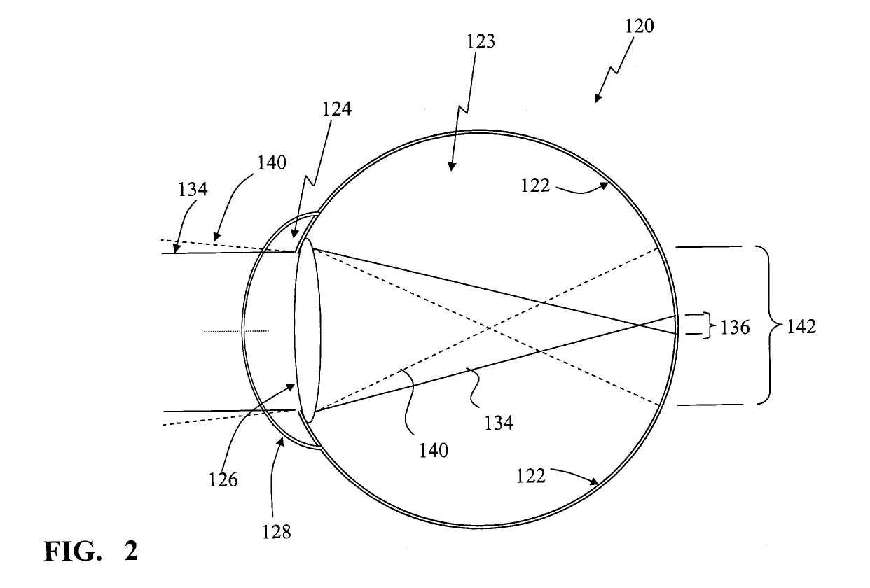

These optical power limits are set because of the potential injuries that can result to an individual who happens to view the free-space optical signals. Optical signals at various wavelengths λ are absorbed at different locations in the eye because of the absorption that results when optical energy comes into contact with photon absorbing moisture found in the aqueous and vitreous fluids 123, 124 in the human eye. FIG. 2 depicts a simplified anatomical diagram of a cross-sectional view of the human eye 120. Optical signals 134 and 140 with wavelengths in the 400 nm to 1400 nm range are not easily absorbed in the eye's natural fluids and are instead focused onto the retina 122 where images created from chemical responses with both rods and cones in the fovea centrallis, or central fovea area. Conversely, optical signals 134, 140 at a wavelength of 1550 nm experience significant absorption in moisture and therefore are attenuated by the aqueous fluid 124 in front of the eye's lens 126.

Because light at wavelengths between 400 and 1400 nm is not absorbed in the eye's aqueous fluids, most if not all of the optical power received by the eye is focused on the retina 122. As a result, optical signals 134, 140 can cause damage to the retina if a beam with a large enough optical power is viewed for too long. Optical signals at wavelengths around 1550 nm are not any more or less safe because they are absorbed by aqueous fluids of the eye. Alternatively, damaging effects on the eye caused by optical beams of 1550 nm wavelength more likely occur near the cornea 128 and lens 126 rather than at the retina 122 and fovea centrallis.

As such, many countries around the world limit the optical power that can be utilized when transmitting optical signals over free-space in the event that someone could inadvertently view the optical signal. Similarly, the optical power allowed is different for different wavelengths and different types of light sources. As discussed above, many countries follow optical power guidelines established by the IEC, which has generated limits for the amount of optical power density at which a free-space optical beam can be generated depending on the wavelength λ, the type of optical source and other similar criteria. For example, optical signals having wavelengths λ in the ranges of 400-1400 nm are limited to a different power density function than optical signals with wavelengths λ outside the range 400-1400 nm, such as optical signals at 1550 nm.

Intra-beam viewing of a small source or point source of light 134 (typically, having a subtended angle of α<1.5 mrad) produces a very small focal spot 136 on the retina 122 resulting in a greatly increased power density and an increased chance of laser light tissue damage to the eye 120. A large source of light such as a diffused reflection of a laser beam produces light that enters the eye 120 at a large angle and is referred to as an extended source 140 (typically having a subtended angle α>1.5 mrad). An extended source 140 produces a relatively large image 142 on the retina 122 and energy is not concentrated on a small area of the retina as is the case for a point source laser. This minimizes the risk for damage; allowing a correction scalar to be applied to the allowable power P that can be transmitted in free-space communication as defined by the IEC specification.

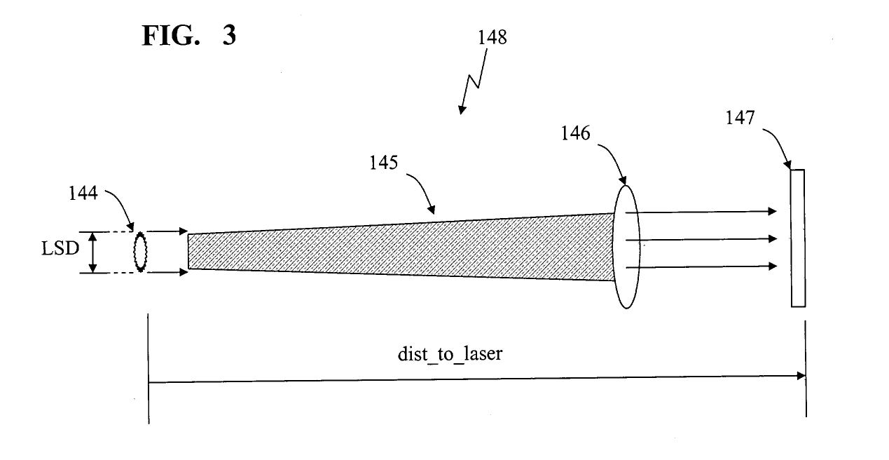

These different power density levels at different wavelengths are advantageously utilized by the present free-space optical communication system to allow an increased link margin, while maintaining the same laser safety classification. FIG. 3 depicts a simplified block diagram of one method for measuring power density levels and determining compliance with eye safe regulations. A laser source 144 generates a laser beam 145. Typically, the beam is directed to impinge on optical elements 146, such as a collimating lens and/or other optical elements. In this example, the collimating lens collimates the beam and directs the beam to exit through a transmitting device external window 147 into free-space. The laser source diameter (LSD) is known, and the distance from the source to the window (dist_to_laser) is used to determine the placement of measurement tools.

Table 1 below includes an excerpt from the IEC 60825-1:2001/A2 standard (incorporated in its entirety herein by reference) for Class 1 and Class 1M free-space optical beams at wavelengths λ of 850 nm and 1550 nm. When measuring an optical transmitter to determine the laser power classification, the class and condition is initially assumed. This assumption determines the aperture size used to scan the cross section of the beam and at what distance from the beam source the power density is measured. For example, using condition 1 for Class 1M at 850 nm, it can be seen in Table 1 that the aperture size is 7 mm and the distance from the laser source to the 7 mm aperture is to be 100 mm. Additionally, if the laser source is further than the indicated distance (e.g., >100 mm from the source) inside an optical source generator unit before it exits the unit, then the distance from the source to the exit point of the unit is used as the alternative distance in the measurement.

TABLE 1
IEC LIGHT POWER DENSITY LIMITATIONS

| | | | | Power |
|---|---|---|---|---|
| | Power | Aperture | Distance | Density |
| Wavelength 850 nm | (mW) | Size (mm) | (mm) | (W/cm²) |
| IEC/CDRH Class 1: | 0.78 | 50 | 2000 | 0.04 |
| (C1) | | | | |
| Condition 2 (C2) | 0.78 | 7 | r | 2.03 |
| | | | (see EQ. 6) | |
| IEC/CDRH Class 1M: | 0.78 | 7 | 100 | 2.03 |
| (C1) | | | | |
| Condition 2 (C2) | 500 | 7 | 14 | 1299.88 |
| Condition 3 (C3) | 500 | 50 | 2000 | 25.48 |

| | Power | Aperture | Distance | Power |
|---|---|---|---|---|
| Wavelength 1550 nm | (mW) | Size (mm) | (mm) | Density |
| IEC/CDRH Class 1: (C1) | 10 | 25 | 2000 | 2.04 |
| Condition 2 (C2) | 10 | 7 | 14 | 26.00 |
| IEC/CDRH Class 1M: (C1) | 10 | 3.5 | 100 | 103.99 |
| Condition 2 (C2) | 500 | 7 | 14 | 1299.88 |
| Condition 3 (C3) | 500 | 25 | 2000 | 101.91 |

The power limits associated with an optical beam for Class 1 and Class 1M from Table 1 of the IEC 60825-1:2001/A2 standard for optical beams in the wavelength range between 700-1400 nm can be calculated by:

P=0.7*C4*C6*C7/T₂^{1/4} mW. EQ. 1

C4 is a wavelength-dependent function for wavelengths between 700-1400 nm. At a wavelength of 850 nm C4 has a value of 2.0 (as defined according to the IEC specifications). C7 is also a wavelength-dependent function for the wavelength range of 700-1400 nm. At a wavelength of 850 nm C7 has a value of 1.0.

C6 is a correction fact that is defined as:

$$C6 = \frac{α}{{α}_{min}} , \qquad EQ . 2$$

where αₘᵢₙ is the minimum angle subtense that is specified as 1.5 mrad. The α symbol represents the angle (in mrad) subtended by the apparent source when measured at a distance of 100 mm from that source, or at the nearest point of access, if the source is recessed more than 100 mm within a laser or optical beam generator. Referring to FIG. 3, typically, the apparent source size is determined by the optical image of the source as viewed through the system optics. If the system has no optical elements, then the subtended angle α can be estimated by:

$$α = \frac{LSD}{dist\_to \_laser} , \qquad EQ . 3$$

where the light-source diameter (LSD) is divided by the distance to the laser or source (dist_to_laser). For a simple optical element, a collimating laser lens, the apparent source size is substantially a constant, independent of the viewing distance and given by:

$$α = \frac{LSD}{FL} , \qquad EQ . 4$$

where FL is the focal length of the lens. In some embodiments, the apparent size is limited by the diameter of the collimating lens at a sufficiently large enough viewing distance. Other general optical configurations are possible. Some embodiments utilize collimated source configurations to minimize link margin losses to acceptable levels.

The T₂ term of Equation 1 is defined as a maximum period of exposure, which is a function of α, and it varies from a minimum of 10 sec (at α=1.5 mrad) to a maximum of 100 sec (at α=100 mrad). C4, C6, C7 and T₂ are defined in the Notes to Table 1-4 in the IEC 60825-1:2001 standard, and C4, C6, and C7 each have a minimum value of 1. As such, an optical signal at a wavelength of 850 nm is defined as:

P=0.7*2*C6*1/T₂^{1/4}=1.4*C6/T₂^{1/4} mW. EQ. 5

A light source is typically defined as a point source when the subtended angle α is less than or equal to 1.5 mrad. When α<1.5 mrad, the resulting C6 and T₂ variables of Equation 5 can be determined to be C6=1 and T₂=10, according to the IEC standard. As such, the maximum Class 1 or 1M power at which a point source can emit an optical beam into a 7 mm aperture is:

P=1.4*1*1/10^{1/4}=0.787 mW.

For 850 nm optical signals defined as Class 1, the power limit of 0.78 mW must be met under both Condition 1 and Condition 2 defined by the IEC. Referring to Table 1 above, the maximum power for a point source measured with a 50 mm aperture at a distance of 2000 mm from the source (or from the closest access point to the source) cannot exceed 0.78 mW. The maximum power also cannot exceed 0.78 mW when measured with a 7 mm aperture size at a distance of 14 mm from the optical source (or from an exit point of an optical beam generator if the apparent source is recessed more than 100 mm inside the generator). This power limit level of 0.78 mW is a significant factor in the performance limits for a broadly deployable free-space optical communication system, relative to the link margin that can be constructed to deal with a dynamic transmission medium like the atmosphere.

Still referring to Table 1, for an 850 nm wavelength point source, defined as Class 1M, the power of the optical beam cannot exceed 0.78 mW when measured with a 7 mm aperture at a distance of 100 mm from the light source (or at an exit point of an optical beam generator where the apparent source is recessed more than 100 mm inside). Additionally, the optical signal cannot exceed a Class IIIb limit of 500 mW when measured with a 7 mm aperture at a distance of 14 mm from the source (or at an exit window when the source is recessed by at least 14 mm in accordance with condition 2, Table 1) as well as when measured with a 50 mm aperture at a distance of 2000 mm from the optical source (condition 3 from Table 1).

Alternately, an optical light source can be defined as an extended light source, if the subtended angle of the apparent source is greater than 1.5 mrad (i.e., α>1.5 mrad). If a light source has a subtended angle α greater than 1.5 mrad, then that light source can generate higher power limits than point sources. The reason being is that the hazard of injury is reduced, due to the larger resultant spot size 142 (see FIG. 2) on the retina 122. Similarly, referring to Equation 2, the correction factor, C6, is also increased, because the subtended angle α is greater than αₘᵢₙ. The resulting product is greater than 1, and thus increases the power P defined in Equation 5. For example, with an 850 nm light beam from a fiber optic source collimated by a simple convex lens of focal length of 150 mm, a rough calculation indicates that the apparent source size should be greater than 225 μm for the ratio of α to αₘᵢₙ to be greater than 1 thereby changing the C6 correction factor to something greater than 1 and increasing P. Otherwise, the source is still considered a point source laser and C6 remains 1 and does not increase the power limits. Further, T₂ is also dependent on the subtended angle α, and as α increases so does the value of T₂. Increasing T₂ (≧10 sec) decreases the value of the allowed transmit power P (as defined by Equation 5). However, this is done, in some embodiments, at a very slow rate (T₂^{-1/4}) so that the extended source still produces a net allowed power increase.

In determining the power limit P as defined by Equation 5, the subtended angle α (in the spectral band between 400 nm to 1400 nm) is first calculated, and then the C6 and T₂ parameters are determined. According to the IEC standard, for Class 1, Condition 1, the power is measured with a 50 mm aperture at a distance of 2000 mm from the source (see Table 1 for aperture and distances). For that calculation, the value of the apparent angle, α, is determined at that same distance. Optionally, the actual subtended angle can be further multiplied by an assumed magnification factor (e.g., 7×) of the collecting optics to determine a (provided that the criteria of IEC 60825-1:2001/A2 standard in the fourth paragraph 8.4c incorporated by reference is met). This subtended angle is limited by αₘₐₓ=100 mr in the calculation. Once a is determined, the C6 and T₂ parameters can then be calculated from the value of α.

For Condition 2 of Class 1, the power is measured with a 7 mm aperture 14 mm from the exit aperture, if the source is less than αₘᵢₙ. If α≧αₘₐₓ=100 mr, then the 7 mm aperture is placed at 100 mm from the source. Where the source is recessed more than 100 mm, the aperture is placed at the exit aperture. For values between αₘᵢₙ and αₘₐₓ, the 7 mm aperture is placed at:

$$r = 100 mm * \sqrt{\frac{α + 0.46 mr}{{α}_{max}}} . \qquad EQ . 6$$

Similarly, for Class 1M, the power limit as defined by Equation 5 is met when measured with a 7 mm aperture at a distance of 100 mm from the source (or at the window for apparent sources recessed more than 100 mm inside). The value of α is determined and for this criterion, C6 and T2 are calculated from this a.

In addition, the power cannot exceed the Class IIIb limit of 500 mW when measured with a 50 mm aperture at a distance of 2000 mm from the source, as well as when measured with a 7 mm aperture at a distance of 14 mm (or at the window for apparent sources recessed at least 14 mm).

For example, if the calculated subtended angle α is determined to be α=6.7 mrad, then C6 can be calculated according to Equation 2 as:

$$C6 = \frac{α}{{α}_{min}} = \frac{6.7 mrad}{1.6 mrad} = 4.47 ,$$

and T₂ can be calculated as:

$${T}_{2} = 10 \times {10}^{\frac{6.7 mrad - 1.5 mrad}{98.5}} = 11.3 seconds .$$

Once C6 and T₂ are known, the power limit can be calculated according to Equation 5 to be:

P=1.4*4.44(11.3^{-1/4})=3.4 mW.

This extended source with a subtended angle α=6.7 mrad allows for a maximum power of 3.4 mW, versus the 0.78 mW with the point source. This increased power of 3.4 mW is 4.36 times the power allowed for the point source at laser Class 1M for wavelengths λ in the range of 400-1400 nm.

The present invention provides apparatuses and methods for communicating optical signals through free-space using an extended source laser, in order to increase the allowable power at eye safe levels within a specific laser safety classification. As described above, the primary constraint is the power density called out by wavelength in accordance with the IEC 60825-1/A2 standard.

As a result, the present invention optimizes the transmit power by utilizing extended sources. In implementing one or more extended sources the present invention increases the subtended angle α to a value greater than αₘᵢₙ so that their ratio is greater than 1. This change also increases T₂, the maximum period of exposure, from 10 sec (point source) up to 100 sec for α≧αₘₐₓ=100 mrad. As a result, the factor T₂^{-1/4} decreases the allowed power by a factor of 0.316 for αₘₐₓ compared to the standard factor of 0.562 for the point source. As a result, the factor T₂^{-1/4} can decrease the laser safe power by at most 0.562, while the power increases linearly with α up to the limit of αₘₐₓ.

It is noted based on Equations 1-5, two parameters can be varied in order to increase the subtended angle α. First, the laser source diameter (LSD) can be increased (see Equation 3 and 4) to some value that produces an a greater than αₘᵢₙ (e.g., larger than 225 μm for the 150 mm collimating lens example up to a limit of 15 mm which produces an α of about 100 mrad). Secondly, the distance from the laser to the exit point from the transmitter window can be decreased. This value, whether it is a distance recessed or the focal length of the collimating lens, in the denominator of Equation 2 would have to be decreased to inversely affect an increase in the subtended angle α. The minimum distance is often constrained by the minimum optical blur circle size, the minimum f-number (f/#) and the maximum numerical aperture (NA) for the optical path.

As such, the present invention utilizes one or more of these options in generating a laser source for free-space optical communication where the subtended angle α is greater than αₘᵢₙ by a sufficient amount to allow for greater power to be transmitted. This greater power when applied to free-space optical communication systems increases the link margin of an extended source system, while maintaining the same laser safety classification.

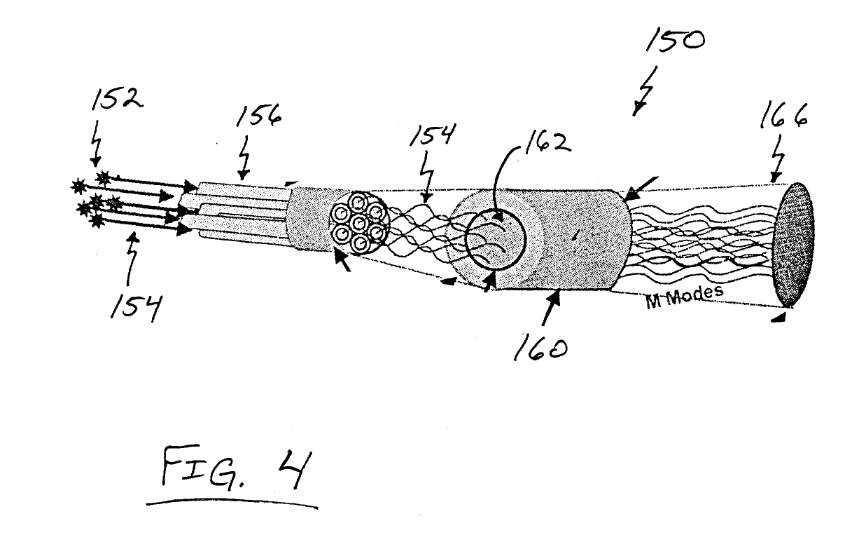

FIG. 4 depicts a simplified block diagram of an extended laser transmission source 150 according to one embodiment of the present invention. One or more optical beam or light sources 152, for example one or more laser sources, are optically aligned with one or more optical beam carriers, such as fiber optic cables 156. The light sources 152 are configured to direct optical beams 154 into one or more fiber optic cables 156. These fiber optic cables can be single mode or multimode fiber optic cables. One or more of the fiber optic cables 156 are optically aligned with one or more large diameter core fiber optic cables 160 such that the optical beams 154 are directed into the core 162 of the large diameter fiber optic cable. In one embodiment, the large core fiber is a multimode fiber.

The large diameter fiber optic cable 160 is configured such that the core 162 is large enough to establish an output signal 166 that has a subtended angle α that exceeds the αₘᵢₙ and qualifies as an extended source. As such the large core fiber optic cable establishes an extended source optical beam generator. For example, with the optical signals 154 being generated at a wavelength λ of 850 nm, the diameter of the core 162 is typically at least 225 μm and preferably between 225 μm and 15 mm. The number of modes excited in the large core fiber 160 is large and preferably maximized in order to optimize the extent of illumination of the exit fiber core 162. If the core is not substantially fully illuminated, the value of the actual emission from the fiber is less than the core diameter, and produces an extended source smaller than:

$$α = \frac{{d}_{core}}{FL} ,$$

where d_{core} is the fiber core diameter and FL is the focal length. This could result in an output that violates the calculated safety requirements. Further, in some embodiments to accomplish the optimized mode filling for substantially full and preferably full exit core illumination, the diameters of the input fibers 156 are maintained above a minimum diameter, and a sufficiently large numbers of input fibers 156 are used to maximize the exercised modes. For example, four input fibers 156 can be utilized in a quad arrangement with 500-600 micron diameters to illuminate a 1.5 mm core output fiber 160.

Further, the large diameter fiber 160 is configured to optimize the number of modes exercised within the fiber to produce an output optical signal 166 with a maximal number of exercised modes M. Mechanical bends of the fiber can also be utilized to facilitate mode filling. But, special bend structures (e.g., dog-legs and axial dependence) are typically utilized, as the diameters of the fibers used increase, to establish a substantially symmetrical filling of modes, which provide substantially equal illumination at the exit core.

The angle at which an optical signal enters into a fiber is typically the same angle at which the signal exits at the other end of the fiber. These possible angles for a given wavelength within a fiber are referred to as the M modes in the fiber. The present invention utilizes one or more smaller core single or multi-mode fibers 156 to feed the larger core fiber 160. The present invention optimizes the modes of the large core fiber that are exercised and expands the light within the core into the allowable modes in the larger fiber such that the output light 166 closely fills, and preferably completely fills the numerical aperture (NA) of the larger core fiber 150 establishing an extended source fiber. The number of modes available can be estimated by M=(n*NA*(d/λ))², where λ is a wavelength, NA is the fiber numerical aperture, and d is a fiber core diameter. The modes are the different angles of refraction that can occur for a give wavelength λ within a fiber core.

If only a small subset of the M modes are used, then light exiting the larger core fiber does not substantially fill the NA of the fiber 160 and the power density calculation, as described above in reference to the IEC standards, is invalid when measuring the laser power. The subset can be determined by illumination of the in focus exit fiber core 162 when viewed through a collimated camera system equipped with software to analyze the level of fiber illumination. Such software can be utilized to quantify a 1/e illumination level of the fiber image to establish α.

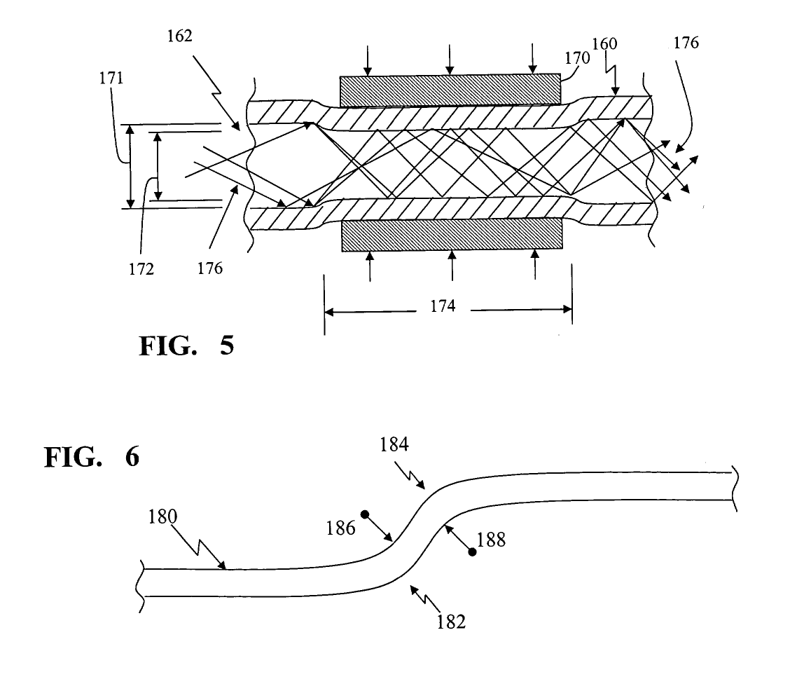

As such, the present invention manipulates the large core fiber 160 such that substantially all, and preferably all of the modes M of the fiber are exercised. In one embodiment, the present invention utilizes bends within the large core fiber 160 to exercise or mode mix additional M modes. FIG. 5 depicts simplified block diagram cross-sectional view of a large core fiber 160 with a fiber clamp 170 position on or about the fiber. In one embodiment, the present invention utilizes one or more clamps 170 about at least a portion of the large core fiber 160 to alter the diameter 171, 172 of sections 174 of the large core fiber 160 to exercise additional modes M. The altered diameter of the core causes the light 176 reflected along the fiber core 162 to disperse at an increased number of angles due to the transition portions and varying diameter 171, 172 within the core 162, and thus increasing the number of modes M being utilized.

In one embodiment, the present invention takes advantage of the bend radius of the large core fiber to maximize the number of M modes utilized in the large core fiber 160. A proper combination of fiber length and bend radius, parameters readily known to optical designers, are balanced to achieve the desired effects within the large core fiber to distribute the optical power over the entire area of the extended source.

In exercising a majority, and preferably substantially all of the M modes, to fill more of the aperture, the present invention provides more of an extended source which can be implemented within a small product size. By maximizing the modes exercised within the fiber core, multiple spots corresponding to the individual light sources and/or individual input fibers 156 do not appear at the far field, but rather a distributed or top hat optical signal is achieved. Further, a power distribution for the output signal 166 is also distributed once the input beams 154 are properly mixed to exercise the M modes of the large core fiber eliminating variations in optical power density (hot spots) seen by a free-space optical communication receiver portion of a free-space optical communication transceiver system 102 (see FIG. 1).

In one embodiment, the large core fiber can be curved, bent or include a jog to exercise modes. FIG. 6 depicts a simplified block diagram of an elevated view of an optical fiber 180 that includes a jog or generally “S” shaped bend to further exercise the modes of the fiber. This implementation is particularly effective for large core fibers. The bends 182 and 184 of the fiber 180 are implemented without exceeding bend radiuses 186 and 188 of the fiber. As such, the fiber is not damaged while maximizing the number of modes exercised. Other similar configurations can be employed to further exercise modes within the fiber core.

Referring back to FIG. 4, in one embodiment, the light sources 152 are implemented through a plurality of low cost, low power optical beam generators that are combined to provide an aggregated output. The aggregated output has a power level that is a sum of the low power optical beams while still being less than the prescribed limits according to the IEC standard.

In one embodiment, the present invention utilizes multiple lasers operating from a common laser driver to provide a redundant source of optical power that can be aggregated together into a single transmitter aperture that complies with an extended source subtense angle, which allows more power to be transmitted at eye-safe laser safety classification levels such as IEC Class 1, and Class 1M. The present invention provides a method to accomplish laser power aggregation allowing multiple lasers to contribute to a greater link margin at a subtended angle larger than 1.5 mrads creating a very cost effective use of optical power.

The plurality of lasers can be low cost, low power lasers. In configuring the transmit beam as an extended source, larger powers can be transmitted, and utilizing the aggregate of a plurality of low cost, low power lasers, the present invention can generate a transmit signal with greater power at a reduced cost.

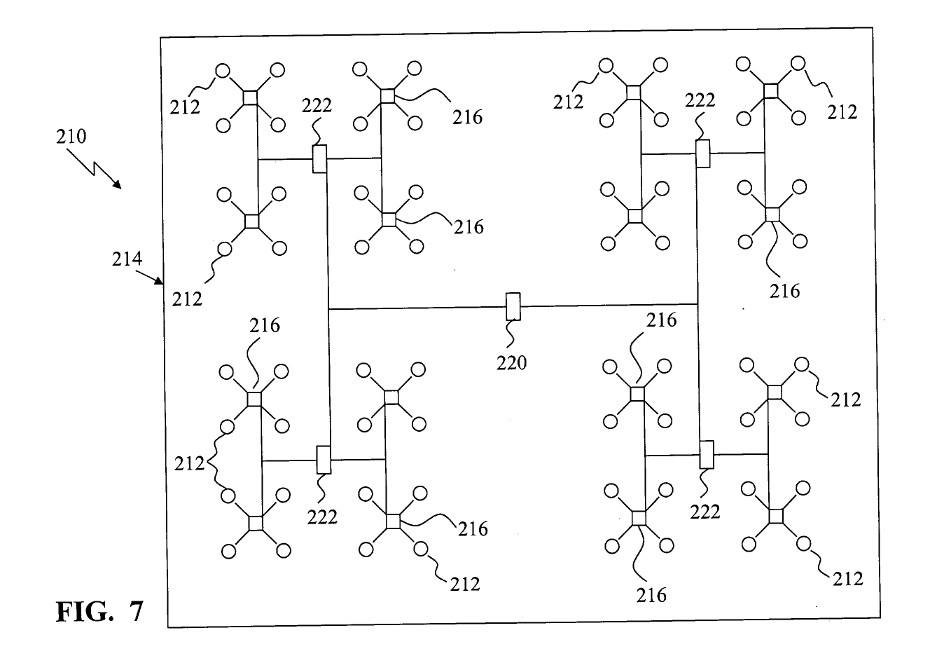

FIG. 7 depicts a simplified schematic diagram of multi-laser source 210 according to one embodiment of the present invention. A plurality of laser sources 212, such as laser diodes, are distributed about a board, microchip, circuit board 214 or other structure. The laser sources can be distributed in a matrix, array, or other distribution. In one embodiment, a plurality of electronics 216, such as optical drivers for driving laser diodes, are included on the board 214. The plurality of electronics can transmit data signals to the laser source 212 to drive or modulate the incoherent laser sources in the generation of optical signals. Each of the plurality of electronics 216 can control one or more laser sources 212.

In one embodiment, a central electronic device 220 activates and/or controls each of the plurality of electronics 216, and/or controls a plurality of sub-central electronics 222 which in turn each control a plurality of electronic devices 216. In configuring the multi-laser source 210, each of a plurality of laser sources 212 controlled by a single electronic device 216 are distributed at equal signal distances from the electronic device. Further, each of the electronic devices 216 are further distributed at equal distances or signal distances from the sub-central electronic devices 222 or the central electronic device 220, and each of the sub-electronic devices are distributed at equal distances from the central electronic device 220. As such, the signals to the plurality of laser sources 212 are maintained to synchronize the signals with respect to data transmission, ensuring that external signals to the central electronic device 220 are forwarded by the central electronic device and are received at each of the laser sources 212 at substantially the same time.

Additionally, the signal distance between a central electronic device 220 and the plurality of laser sources 212 for a given channel are all substantially equal. The present invention can utilize a common fanout laser driver that drives multiple lasers simultaneously minimizing the symbol jitter between laser sources. Thus, the present invention can be configured to provide an extended source to increase allowable power within a laser class using multiple incoherent lasers driven by common circuitry with redundant data.

The present invention can utilize a plurality of electronics 216 to drive a plurality of optical signal sources 212 to generate a plurality of optical beams. The plurality of generated beams can be summed allowing the multi-laser source 210 to operate at lower current levels. Operating at lower current levels allows the present apparatus to provide increased data rates. Distributing the laser sources 212 at substantially equal signal distances from the electronics 216 ensures the latency is substantially the same for each laser source.

The distributed laser source array 210 can include the plurality of electronic devices 216, 220, 222 on the board. Alternatively, in one embodiment, the apparatus 210 includes a laser driver chip that includes a plurality of laser drivers. A single laser driver of the driver chip can be configured to drive one laser source, or a plurality of sources. The signal distance from each laser driver of the driver chip to each laser source is configured to be substantially equal to ensure a signal delay is substantially equal between each of the drivers and the sources.

Utilizing the plurality of laser sources 212 allows the apparatus to combine the beams to achieve a higher total transmit beam power while complying with lower beam power safety regulations as described above. For example, a plurality of transmit beams can be summed and the resulting summation output can be set at levels that meet eye safety standards while the total beam power of the combined transmitted optical signals is great enough to ensure accurate communication. The plurality of low power beams achieves a total needed power for accurate communication with a low power density.

In one embodiment, compensation control is utilized to monitor one or more or all of the laser sources. The compensation control provides information back to the laser driver(s) 216, sub-central and central electronic devices 222, 220, and/or a controller as an intelligent feedback loop to maintain the laser threshold current. The feedback provides accurate control such that the laser sources operate within a linear operating range, preferably for the lifetime of the multi-laser source 210. The feedback, temperature and/or current levels can be monitored and made accessible to a network or system control management system that can report the laser lifetime progress. The progress report can be used to schedule maintenance for the product, for example in the event a laser source prematurely fails.

The multi-laser source 210 is further described in detail in co-pending U.S. patent application Ser. No. 10/218,684, entitled APPARATUS AND METHOD FOR FREE-SPACE OPTICAL COMMUNICATION, filed Aug. 13, 2002, which is incorporated in its entirety herein by reference.

The optical signals generated by a plurality of the laser sources 212 can be combined into one or more optical beams to establish an extended source. Further, the multi-laser source 210 can be implemented to provide scaled power. For example, one or more laser sources 212 can be aggregated to generate an extended source output beam to be transmitted over free-space. The power level of the transmitted beam can be controlled and adjusted by adding or removing beams by activating and deactivating one or more laser sources 212. Thus, a maximum power can be achieved without exceeding eye safe power levels.

In one embodiment, a plurality (or all) of the laser sources 212 of the multi-laser source 210 are each optically aligned with a single mode or multimode fiber, similar to that depicted in FIG. 3. The plurality of fibers are optically aligned with a large diameter multimode fiber 160. The diameter of the fiber core is such that the output of the large core fiber establishes an extended source outputting the combined optical signals. Further, the large diameter fiber is configured to optimally exercise the modes M of the fiber.

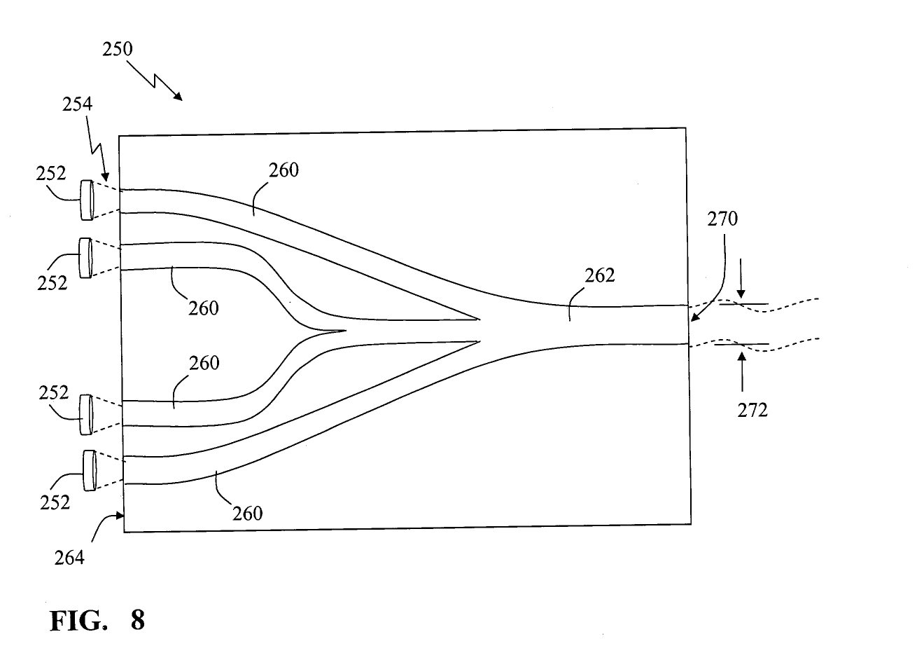

In one embodiment, a plurality of the laser sources 212 are each optically coupled with a wave guide such that the wave guide aggregates the separate beams into a single beam. FIG. 8 depicts a simplified block diagram cross-sectional view of a wave guide 250 optically aligned with a plurality of laser sources 252. Optical beams 254 are generated by the laser sources 252, and each optical beam is directed into one of a plurality of guides 260. The guides converge to combine the optical beams into a single output guide 262. Preferably, each guide has substantially the same length from the entry surface 264 to an output surface 266. In one embodiment, the output aperture 270 is configured to have a diameter 272 large enough to ensure the subtended angle is greater than the minimum subtended angle to establish the output as an extended source. For example, the output diameter 272 can be between approximately 225 μm and 15 mm for the communication of an 850 nm wavelength output beam 280 when coupled to a 150 mm collimating lens. The wave guide 250 can be configured with any number of guides 260 in substantially any configuration, for example as an array of guides converging to a single or multiple output guides 262.

A plurality of wave guides can be combined or stacked to form a matrix of wave guides that can optically couple with a matrix of laser sources 212. Additionally, a second level (or a plurality of levels) of wave guides can be utilized to combine the signals combined by a first level of guides. Again, the output of the final wave guide can be configured to qualify as an extended source.

In one embodiment, the wave guides are also configured to optimize M modes within the wave guides. Modes are further exercised at the junction points within the waveguide where two or more guides merge. Alternatively and/or additionally, the wave guide output 270 can be optically aligned with a large core fiber optic, an extended source telescope or other similar extended source apparatuses for establishing and transmitting a final free-space optical signal.

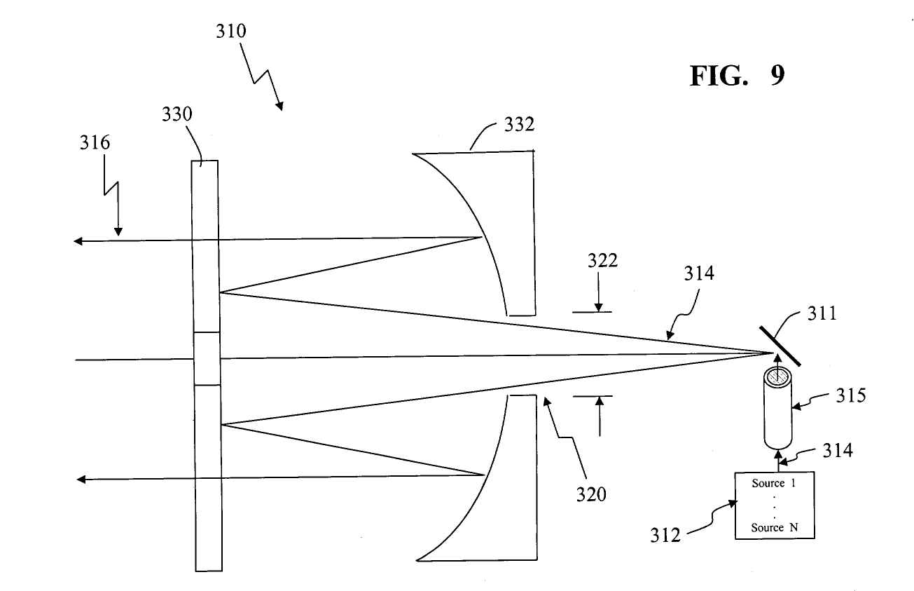

FIG. 9 depicts a simplified block diagram cross-sectional view of a telescope 310 configured as an extended light source or extended optical beam generator according to one embodiment of the present invention. One or more optical beam sources 312, such a laser diodes, VCSEL array(s) or other optical signal generators, are optically aligned with and/or propagated to direct a plurality of optical beams into a large core fiber 315, waveguide or other component to establish the source as an extended source. The large core fiber can be configured to exercise additional modes if needed. The beams are directed from the large core fiber 315 to impinge on a directional mirror or reflective element 311 such that one or more beams 314 are directed through the telescope 310 to generate a single extended source output beam 316. The plurality of optical beams 314 are directed through an input optical aperture 320.

In one embodiment, the beam(s) 314 can be directed to impinge on a secondary reflective element 330 that reflects the beam(s) towards a primary reflector or mirror 332. The secondary reflective element can be a secondary mirror. In one embodiment, the secondary reflective element 330 is a lens that includes or is coated with a polarizing material such that the initial beams 314 can be reflected by the reflective element and then passed through the secondary element 330 after reflecting from the primary reflector 332. The primary reflector 332 directs the beam(s) 314 resulting in the transmit output beam 316.

Further, the telescope 310 is configured such that it is an extended source. This is achieved by utilizing an input optical aperture 320 with a diameter 322 that ensures compliance with an extended source subtense angle where the subtended angle exceeds the minimum subtended angle (i.e., α>αₘᵢₙ). For example, when generating an optical beam at 850 nm, the diameter 322 is typically between 225 μm and 15 mm for a focal length of 150 mm. Operating as an extended source the telescope can transmit more power at eye-safe laser safety classification levels such as IEC Class 1M than can be generated with a point source.

In utilizing the plurality of sources 312, the sources can be implemented through low cost, low power sources that are aggregated through the directional mirror 311 and telescope structure. As such, the increased power of the output beam 316 achieved through the implementation of the extended source telescope 310 can be generated at reduced costs.

In one embodiment, the present invention utilizes a vertical cavity surface emitting laser (VCSEL) array to generate the initial beams that can be aggregated to form the final extended source transmit beam 166, 316 (see FIGS. 3 and 7). A plurality of VCSELs can be configured on a single chip to provide a VSCEL array. The present invention can implement a VSCEL array to provide a scalable architecture that allows additional lasers to be added until the upper bound of power for the subtended angle limits for an extended source are reached. For example, laser outputs from a VSCEL array can be added into a large core fiber until the power limits for the aggregated output beam from a large core multimode fiber is reached.

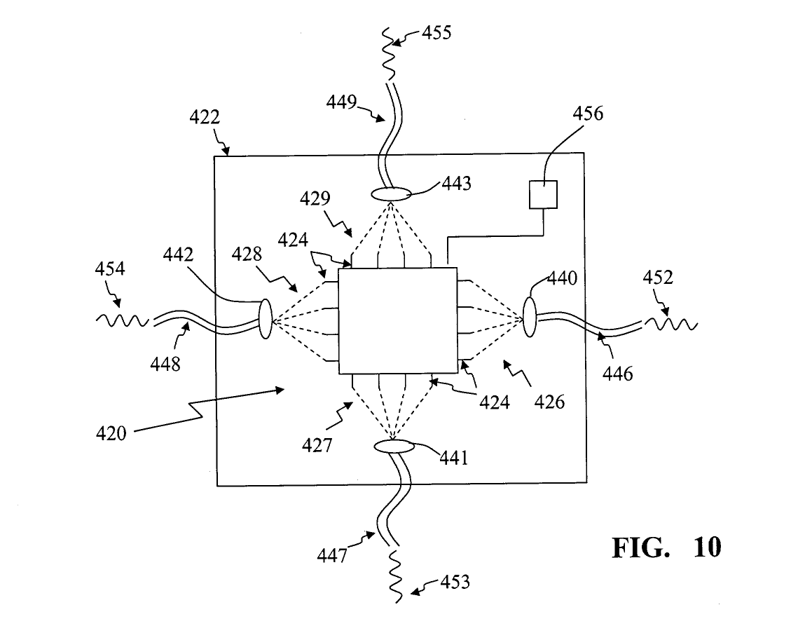

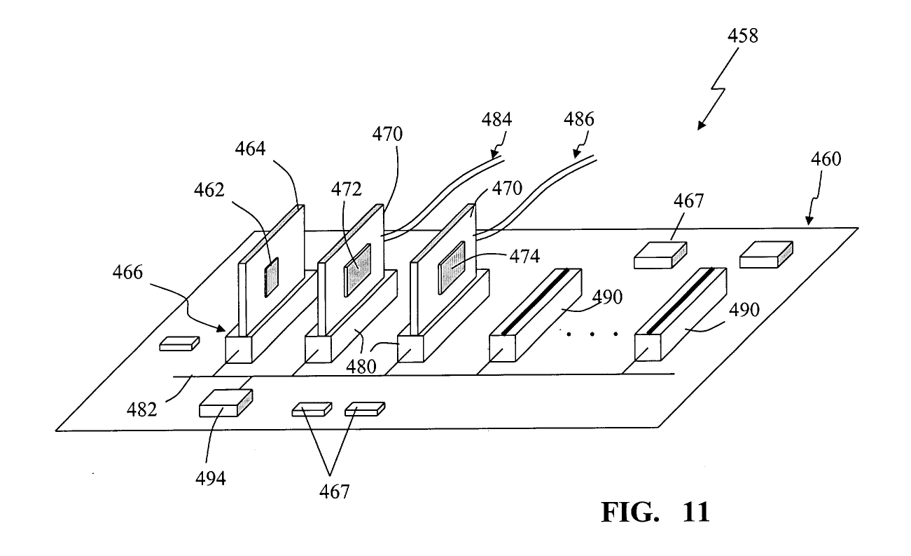

FIG. 10 depicts an example of a simplified block diagram of a VCSEL array 420 mounted onto a card or circuit board 422. The VCSEL array has a plurality of laser outputs 424. In the example shown, four laser outputs are configured on each side of the VCSEL array 420 such that the VCSEL array has, in this example, a total of 16 laser outputs. However, the VCSEL array can be configured with any number of laser outputs 424 in substantially any configuration. A set of laser outputs, for example a first set labeled 426, can be aggregated to a collimating lens 440 to direct the plurality of laser outputs of the first set 426 into an optical signal carrier 446, such as a fiber cable, wave guide or other medium for propagating optical signals, to establish a first aggregated output beam 452 from the fiber 446. The signal carrier 446 can be a single mode fiber or multimode fiber and the modes M of the fiber can be exercised as described above to maximize the number of modes utilized. The other sets 427, 428, 429 of laser outputs can similarly be aggregated through lenses 441, 442, 443, respectively, to provide aggregate output beams 453, 454, 455 through optical signal carriers 447, 448, 449, respectively. One or more of these four aggregate output beams 452-455 can further be combined to provide scaled power for a transmitted optical beam. For example, the four aggregate output beams can be directed into a large core fiber optic cable to establish a low cost extended source that maximizes the output power without exceeding eye safe levels.

In one embodiment, a laser driver is included for each laser source. Alternatively, a laser driver chip 456 can be coupled with one or more VSCEL arrays to drive the lasers 424 of the array. The driver chip 456 can include a plurality of drivers, where each driver drives one or more laser sources 424. The present invention is implemented with precision timing and signal distances such that the skew and timing between the laser driver and the lasers is substantially equal and the latency is the same for each laser.

For example, the driver chip 456 can be configured to include 32 output drives that can driver 32 lasers. The drivers can drive lasers that are distributed, for example distributed over a circuit board similar to the embodiment shown in FIG. 4, packaged in a chip, or other similar configurations. The drivers are established such that the timing is matched from the driver outputs to each laser. In one embodiment, each driver can include current threshold monitoring of the laser. Each driver can additionally include a feedback mechanism for monitoring, and in some embodiments implementing self heating and cooling control.

FIG. 11 depicts a simplified block diagram of a scalable optical laser source 458. The scalable laser source 458 can include a circuit board 460 having a plurality of card slots, sockets or plugs 466, 480, 490. One or more laser driver chips 462 mounted on a driver circuit card 464 is inserted into a driver slot 466 or other device for receiving and electrically coupling the driver card 464 with the circuit board 460. One or more VCSEL array cards and/or a laser array card (similar to that shown in FIG. 4) 470 are additionally included on the circuit board and each includes at least one VCSEL array and/or laser array 472, 474 for generating a plurality of optical beams as described above. Each VCSEL and/or laser array card 470 is inserted into a slot 480 or other device for receiving and coupling the VCSEL and/or laser array cards 470 with the circuit board 460 and other components 467, 494 of the circuit board or other devices coupled with the circuit board. Typically, the laser driver 462 is coupled through a communication link 482, such as a bus or other link, with the VCSEL and/or laser arrays 472, 474 to drive the lasers.

In some embodiments, the signal distance between the laser driver 462 and the first VCSEL array 472 (or laser array) is substantially equal to the signal distance between the laser driver and the second VCSEL array 274 (or laser array). As such, the lasers of the VCSEL and/or laser arrays are driven at substantially the same time to ensure the generation of a plurality of beams with substantially identical latencies. The laser beams generated from each VCSEL and/or laser arrays can be coupled with a fiber optic cable 484, 486, wave guides or other optical beam carriers for propagating the generated lasers to a desired destination. The output of one or more VCSEL and/or laser arrays can be aggregated to provide optical power scaling as described above by adding or removing one or more optical beams from the VCSEL lasers or lasers of the laser array. One or more of these fiber cables 484 can be further combined into a single extended source, for example through one or more large core fibers, through one or more telescopes or other extended source configurations, to provide further optical power scalability.

Through the utilization of the plurality of laser beams generated through the VCSEL and/or laser arrays 472, 474, the final beam transmitted over free-space can be scaled to maximize the available power without exceeding the safety limits, e.g., according to the IEC standards. Each VCSEL and/or laser array can be controlled to limit or increase the number of lasers generating optical beams as well as control over the VCSEL and/or laser array boards 470 to control the number of boards generating beams. In one embodiment, the circuit board 460 can include one or more additional slots 490 that can be utilized to add additional VCSEL and/or laser array cards to allow further scaling of the free-space transmit beam.

In one embodiment, the scalable laser source 458 includes feedback from each VCSEL and/or laser array to the driver 462 and/or a controller 494. The feedback allows control over the scalability as well as monitoring the operation of the scalable laser source 458 and the components of the scalable laser source 458.

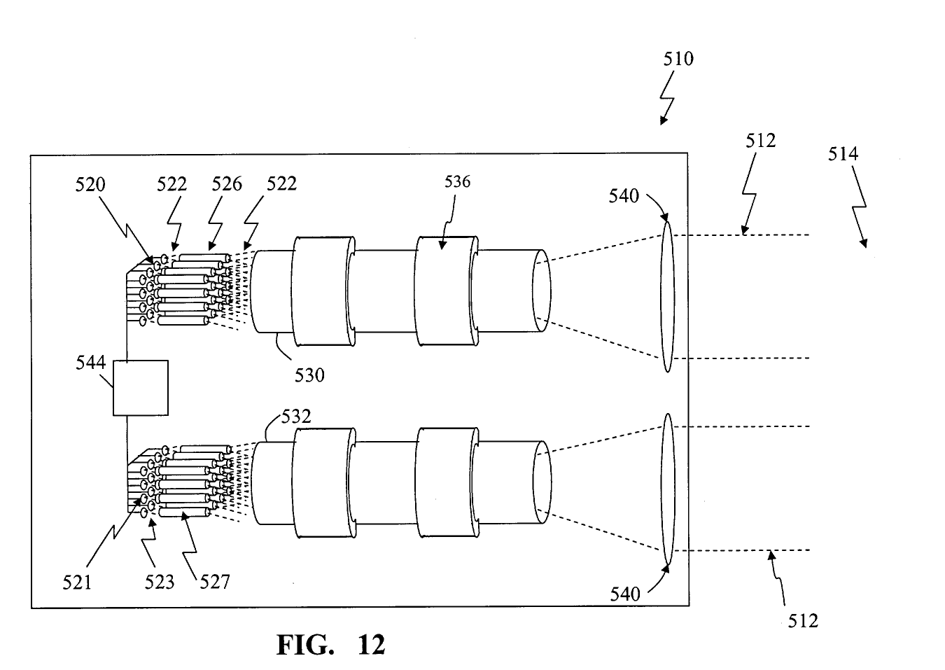

FIG. 12 depicts a simplified block diagram cross-sectional view of a free-space optical transmitter 510. The free-space optical transmitter 510 can be configured to generate two or more extended source optical beams 512 to be projected across a free-space link 514. In one embodiment of the present invention, a plurality of optical sources 520, 521 generate a plurality of duplicative optical beams 522, 523, where each beam carries the same information, data, control signals or other data. A plurality of fiber optic cables 526, 527 optically align with the plurality of optical sources 520, 521 to receive and propagate the optical beams 522, 523. The plurality of fiber optics 526, 527 are divided into two or more sets, where each set is optically aligned with a large core fiber optic cable 530, 532. The large core fibers are configured so that the core has a diameter with a width large enough that the subtended angle exceeds the minimum angle and are extended sources. The two or more large core fiber optic cables are configured to mode mix the optical beams to increase the number of modes M exercised within each large core fiber cable, and preferably maximize the number of modes M exercised within the core, for example through clamps 536, bends or other methods for exercising modes.

Each large core fiber is optically aligned with conditioning optics 540, such as lenses, telescopes, filters and other optics to condition the beams 512 to be transmitted over the free-space link 514.

In one embodiment, the plurality of optical sources 520, 521 are coupled with one or more drivers 544. The drivers can be configured to drive the multiple incoherent optical sources 520, 521 with redundant data such that the optical beams 522 are redundant beams. In one embodiment, the plurality of drivers are positioned such that the signal distance from each driver to each optical source is substantially equal. In one embodiment, the plurality of drivers can be part of a single driver chip or driver board. The sources can be configured on a single circuit board with the drivers coupled directly on the single circuit board. Alternatively, the sources are configured as part of one or more VCSEL arrays. In utilizing and aggregating a plurality of low cost laser sources 522 the present invention provides improved link budget over previous free-space optical communication systems at significantly reduced costs.

The transceiver 510 can also be configured to communicate a plurality of different data. In one embodiment, the first set of sources 520 can generate optical beams 522 based on a first set of data, while the second set of sources 521 can generate optical beams 523 based on a second set of data. Typically, the first and second beams are generated at different wavelengths or oppositely polarized. This allows two different data signals to be generated and transmitted from the transceiver 510 providing signal multiplexing.

In one embodiment, a subset of sources or each individual source of the sets of sources 520, 521 can be driven to communicate different data. For example, if each set of sources is an array of 16 sources, then the transceiver can communicate 32 different data signals. Typically, each source is driven at different wavelengths. As such, the transceiver 510 can provide wavelength division multiplexing (WDM) free-space optical communication.

Referring back to FIG. 1, in one embodiment, the present invention establishes a free-space optical communication link 106 and/or network 102. A remote link head (e.g., 104) receives an extended source optical beam generated through a local extended source link head (e.g., 103) and determines the received optical power. The remote link head 104 is configured to communicate the received power level back to the local link head 103. The local link head utilizes the receive power level to aid in determining if adjustments to the transmitted optical power are needed. For example, if the receive power exceeds a receive power threshold, the local link head does not increase the power. Alternatively, the local link head can reduce the power if the receive power level exceeds a minimum receive power by a predefined level (e.g., shut down or inhibit one or more of a plurality of beam sources from generating beams). Further, if the receive power is less than the receive power threshold, the local link head can determine if the local transmit power exceeds eye safe levels. If the local transmit power does not exceed eye safe levels, the local link head can increase the transmit power, for example by activating one or more additional beam sources.

The remote link head can communicate with the local link head by transmitting an optical signal back over the link 106; by other wireless communication, such as radio frequency, cellular and other modes of wireless communication; by direct coupling, such as fiber optic cables, twisted wire pair and other direct coupling; indirect coupling such as public switching telephony networks, the Internet and other communication networks; and substantially any other mode of communicating.

While the invention herein disclosed has been described by means of specific embodiments and applications thereof, numerous modifications and variations could be made thereto by those skilled in the art without departing from the scope of the invention set forth in the claims.

What is claimed is:

1. An apparatus for optically communicating over free-space, comprising:
a first optical source configured to generate a first optical beam;
a first optical beam carrier optically aligned with the first optical source and configured to propagate at least a portion of the first optical beam; and
an extended source optically aligned with the first optical beam carrier and configured to output an extended source optical beam.

2. The apparatus as claimed in claim 1, wherein the extended source includes an extended source telescope optically aligned with the first optical beam carrier and configured to direct at least a portion of the first optical beam to output the extended source optical beam into free-space.

3. The apparatus as claimed in claim 1, wherein the extended source includes a large core fiber optic cable optically aligned with the first optical beam carrier and configured to propagate at least a portion of the first optical beam, wherein the large core fiber cable outputs the extended source optical beam.

4. The apparatus as claimed in claim 3, wherein the large core fiber optic cable exercises additional modes of the large core fiber cable to generate the extended source optical beam.

5. The apparatus as claimed in claim 3, further comprising:
a second optical source configured to generate a second optical beam;
a second optical beam carrier optically aligned with the second optical source and configured to propagate at least a portion of the second optical beam; and
the large core fiber optic cable optically aligned with the second optical beam carrier and configured to propagate at least a portion of the second optical beam such that the output of the extended optical source includes at least a portion of the first and second optical beams.

6. The apparatus as claimed in claim 5, wherein the first and second optical beams communicate the same data.

7. The apparatus as claimed in claim 5, further comprising:
a first optical source driver coupled with the first optical source and configured to drive the first optical source such that the first optical beam communicates data; and
a second optical source driver coupled with the second optical source and configured to drive the second optical source such that the second optical beam communicates the data.

8. The apparatus as claimed in claim 5, further comprising:
a first optical source driver coupled with the first and second optical sources and configured to drive the first and second optical source such that the first and second optical beams transmit data and the first and second optical sources are positioned substantially an equal signal distance from the first optical source driver.

9. The apparatus as claimed in claim 1, further comprising:
a first optical source card including the first optical source configured to generate the first optical beam;
a second optical source card including a third optical source configured to generate a third optical beam;
a third optical beam carrier optically aligned with the third optical source and configured to propagate at least a portion of the third optical beam; and
the extended source is optically aligned with the third optical beam carrier and configured to generate the extended source optical beam including at least a portion of the first and third optical beams.

10. The apparatus as claimed in claim 9, wherein the first optical source driver coupled with the third optical source, and the first optical source driver is configured to drive the first and third optical sources such that the first and third optical beams communicate data.

11. An apparatus for transmitting optical signals over free-space, comprising:
a plurality of optical beam sources; and
an extended source optical beam generator optically aligned with the plurality of optical beam sources to receive a plurality of optical beams and to transmit an extended source output beam.

12. The apparatus as claimed in claim 11, wherein the extended source optical beam generator includes a telescope for generating the extended source output beam.

13. The apparatus as claimed in claim 12, wherein the telescope includes an input optical aperture that is sufficiently large such that its subtended angle is greater than a minimum laser safe subtended angle.

14. The apparatus as claimed in claim 11, wherein the extended source optical beam generator includes a large core fiber optic cable.

15. The apparatus as claimed in claim 14, wherein the large core fiber optic cable is configured to maximize exercised modes of the fiber.

16. The apparatus as claimed in claim 15, further comprising:
a clamp positioned about at least a portion of the large core fiber optic cable.

17. The apparatus as claimed in claim 11, further comprising:
a vertical cavity surface emitting laser (VSCEL) array including the plurality of optical beam sources.

18. The apparatus as claimed in claim 11, further comprising:
an optical beam source board including the plurality of optical beam sources.

19. The apparatus as claimed in claim 18, wherein the optical beam source board includes a beam source driver wherein at least two of the plurality of optical beam sources are distributed over the optical beam source board at substantially equal signal distances from the first beam source driver.

20. The apparatus as claimed in claim 11, further comprising:
a first additional optical beam source optically aligned with the extended source optical beam generator;
a beam source driver coupled with the first additional optical beam source; and
a controller coupled with the beam source driver, wherein the controller is configured to determine an optical power of the extended source output beam and to activate the beam source driver if the optical power is below a threshold such that the first additional optical beam source generates a first additional optical beam.

21. The apparatus as claimed in claim 11, further comprising:
a first beam source card including the plurality of optical beam sources; and
a second beam source card including a secondary plurality of optical beam sources, wherein the secondary plurality of beam sources are optically aligned with the extended source optical beam generator.

22. The apparatus as claimed in claim 21, further comprising:
a beam source driver coupled with the first and second beam source cards, wherein the beam source driver drives the plurality of optical beam sources of the first card and at least one of the secondary plurality of optical beam sources if an optical power of the extended source output beam is below a threshold.

23. A method of optically communicating over free-space, comprising the steps of:
generating a first optical signal;
coupling the first optical signal to an extended optical signal source; and
generating an extended source output.

24. The method as claimed in claim 23, wherein the step of generating an extended source output includes exercising substantially all modes of a fiber.

25. The method as claimed in claim 24, wherein step of exercising includes clamping a portion of the fiber.

26. The method as claimed in claim 24, wherein the steps of coupling includes coupling the first optical signal from a plurality of input fibers having predefined diameters such that substantially all of the modes of the extended optical signal source are exercised.

27. The method as claimed in claim 24, wherein the step of exercising includes fixing a length of the fiber, bending the fiber, and exercising substantially all of the modes of the fiber.

28. The method as claimed in claim 23, further comprising the steps of:
monitoring an optical power level of the extended source output;
generating a second optical signal if the optical power level is below a threshold;
coupling the second optical signal with the extended optical signal source; and
the step of generating the extended source output includes generating the extended source output with at least the first and second optical signals.

29. The method as claimed in claim 23, further comprising the steps of:
generating a second optical signal such that there is substantially equal latency between the first and second optical signals.

30. The method as claimed in claim 23, further comprising the steps of:
generating a second optical signal from a second optical source card if the optical power level of the extended source output is below a threshold;
wherein the step of generating a first optical signal includes generating a first optical signal from a first optical source card; and
the step of generating the extended source output including generating the extended source output with both the first and second optical signals.

31. The method as claimed in claim 23, wherein the step of coupling the first optical signal to the extended optical signal source including optically aligning the first optical signal with an initial fiber optic cable, and optically aligning the initial fiber optic cable with the extended optical signal source such that at least a portion of the first optical signal is propagated through the initial fiber optic cable to the extended optical signal source.
